(19) United States
(12) Patent Application Publication
(10) Pub. No.: US 2009/0304377 A1
(43) Pub. Date: Dec. 10, 2009

(54) ROTARY JOINT DEVICE, SUPPORT FRAME AND CAMERA APPARATUS

(75) Inventors: Jung Wen CHANG, Taoyuan County (TW); Chun Feng LAI, Sanchong City (TW); Bo Ran YAN, Taichung County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: QUANTA COMPUTER INC., Tao Yuan Shien (TW)

(21) Appl. No.: 12/358,505

(22) Filed: Jan. 23, 2009

(30) Foreign Application Priority Data
Jun. 4, 2008 (TW) 097209827

(51) Int. Cl. G03B 17/56; A47F 5/00

(52) U.S. Cl. 396/428; 248/288.11

(57) ABSTRACT

The invention provides a rotary joint device and a support frame and a camera apparatus therewith. The rotary joint device includes a first rotary member, a second rotary member, and a positioning device. The first rotary member includes a first positioning recess space and a second positioning recess space. The second rotary member is pivotally engaged to the first rotary member and includes a hole. The positioning device includes a body, a resilient, and a positioning part. The body includes an accommodating space. The resilient is accommodated in the accommodating space and is connected to the body and the positioning part respectively. The body is disposed in the hole and is connected to the second rotary member. The positioning part is urged against the first rotary member and is accommodated in the first positioning recess space or the second positioning recess space.

### CROSS-REFERENCE TO RELATED APPLICATIONS

This non-provisional application claims priority under 35 U.S.C. §119(a) on Patent Application No. 097209827 filed in Taiwan on Jun. 4, 2008, the entire contents of which are hereby incorporated by reference.

### BACKGROUND OF THE INVENTION

1. Field of the Invention

The present invention relates to a rotary joint device and a support frame and a camera apparatus equipped with the rotary joint device, and more particularly, to a rotary joint device with locating function, a support frame and a camera apparatus equipped with the rotary joint device.

2. Description of the Prior Art

At present, the hanging-type video camera or photographing on the market usually adopts two ways to adjust positions and angles of the video camera device. Moreover, the angle adjustment may be divided into the angular adjustment between the cantilever and the fixed camera thereon, and the degree rotation adjustment of the cantilever and the fixed frame. Please refer to FIG. 1A, which is a top view of the traditional hanging-type video cameras. The video camera device includes the fixed frame 12 and the cantilever 14. The fixed frame 12 is fixed on the cliff side 10, and the fixed frame 12 pivots to the cantilever 14. The dotted-line part of FIG. 1A expresses the position of the cantilever 14 when the video camera device is put away. Therefore, when one wants to use the video camera device (not shown in FIG. 1A) which is pivoted to the cantilever 14 at another end. The cantilever 14 has to move to the extended or pre-set position (for example, to the position shown in FIG. 1A), from the position of the dotted line. Besides, it is need to fix the cantilever 14 firmly at the extended position, i.e. the relative rotation angle.

At present, there are approximately two kinds of fixed ways regarding the fore-mentioned cantilever 14 and the fixed frame 12: one is by tightly locking a screw with a screw hole; another is by using a quickly releasing and locating cam structure. Please refer to FIG. 1B, which is a schematic drawing of tightly locking a screw with the screw hole. The shape of the fixed frame 12′ is split like a C-shape grip ring, and in the split area, the fixed department 12a and the adjustment department 12b are formed. In the adjustment department 12b, there is a screw hole in which a screw 12c is inserted and tightened. One end of the screw 12c is fixed in the fixed department 12a, and another end is locked with a tighten department 12d. By the tighten department 12d to force the adjustment department 12b to move toward the fixed department 12a, both of the C-shape grip ring of the fixed frame 12′ and the cantilever 14′ are connected to the revolution axis 142, which achieves the purpose of fixing cantilever 14′. However, this kind of fixing method is dependent upon the tightened degree of the tighten department 12d, which is not easy to control and has no positioning functions. In addition, the long-term oversized fixed strength makes the C-shape grip ring distorted and then degrades the grip function gradually.

As for another fixed way, please refer to FIG. 1C. FIG. 1C is a schematic drawing of the quickly releasing and locating cam structure. Different from the locking way in FIG. 1B, both of the fixed department 12a′ and adjustment department 12b′ in FIG. 1C have a coaxial hole, and the column 12c′ penetrates through the hole. One end of the column 12c′ contains a stop department 12c″, which may prevent the fixed department 12a′ from sliding out of the column 12c′. And, another end of column 12c′ is connected pivotally with the spanner 12d′. The spanner 12d′ has a cam structure 12d″ used to push the adjustment department 12b′ tightly toward the fixed department 12a′. As a result, both of the C-shape grip ring of the fixed frame 12′ and cantilever 14′ are connected to the revolution axis 142, which is able to achieve the purpose of fixing the cantilever 14. Meanwhile, the cam structure 12d″ uses a rubber washer 12e to produce a locating result. However, the long-term use of the rubber washer 12e in the cam structure 12d″ may induce hardness and chap, cause the locking strength to be insufficient, and loose locating functions. In addition, because the spanner 12d′ protrudes from the support structure, it may easily become loose by accidently touching and make the fixing function failed.

In short, due to the traditional design of fixed cantilevers, it is easy to make the fixing function failed, loose the locating function, and induce the inconvenience of fixing operation after artificial operation or long-term use.

### SUMMARY OF THE INVENTION

Accordingly, an aspect of the present invention is to provide a rotary joint device with locating function.

Moreover, an aspect of the present invention is to provide a support frame and a camera apparatus equipped with the above-mentioned rotary joint device.

According to an embodiment of the invention, the rotary joint device comprises a first rotary member, a second rotary member, and a positioning device. The first rotary member includes a first positioning recess space and a second positioning recess space. The second rotary member is pivotally engaged with the first rotary member and includes a hole. The positioning device includes a body, a resilient, and a positioning part. The body includes an accommodating space. The resilient is accommodated in the accommodating space and is connected to the body and the positioning part respectively. The body is disposed in the hole and is connected to the second rotary member. The positioning part is urged against the first rotary member and is accommodated in the first positioning recess space or the second positioning recess space.

Therefore, the rotary joint device of the invention can perform the locating function, by using the positioning part urged against the first positioning recess space or the second positioning recess space, without clamping the revolution axis. Moreover, the location and number of the positioning recess spaces of the rotary joint device can be changed so that the rotary joint device is capable of performing multi-positioning and is easier to operate with increased structure reliability.

The support frame of the invention comprises the above-mentioned rotary joint device, a first frame, and a second frame, wherein the first frame is connected to the first rotary member, and the second frame is connected to the second rotary member. Therefore, the invention provides a rotatable support frame with locating function to fit the requirement of supporting with locating function.

The camera apparatus of the invention comprises the above-mentioned support frame and a camera, wherein the camera is engaged with the second frame. Therefore, the invention provides a rotatable camera apparatus with locating function to solve the problem of the fixing structure of conventional cantilever camera. Accordingly, the restoration and operation of the camera apparatus of the present invention are easier than that of the conventional camera, and the stability and service life of the camera apparatus are increased as well.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1A is the top view of the part of the traditional hanging type video camera.

FIG. 1B is a schematic drawing illustrating the way of the screw locking with the screw hole.

FIG. 1C is a schematic drawing illustrating the positioning method of quickly releasing and locating mode.

FIG. 2 is a schematic drawing of a camera apparatus according to this invention.

FIG. 3 is an exploded schematic drawing of the camera apparatus in FIG. 2.

FIG. 4 is the exploded schematic drawing of the rotary joint device shown in FIG. 3.

FIG. 5A is the top view of the rotary joint device.

FIG. 5B is the bottom view of the first base.

FIG. 5C is the rotary joint device in sectional drawing of the line X-X of the FIG. 5A.

FIG. 5D is the sectional drawing of the positioning device while revolving the rotary joint device.

FIG. 6A is the schematic drawing of the fixing frame of the first frame.

FIG. 6B is the schematic drawing of the under cover of the first frame.

FIG. 6C is the schematic drawing of the portion of the support frame.

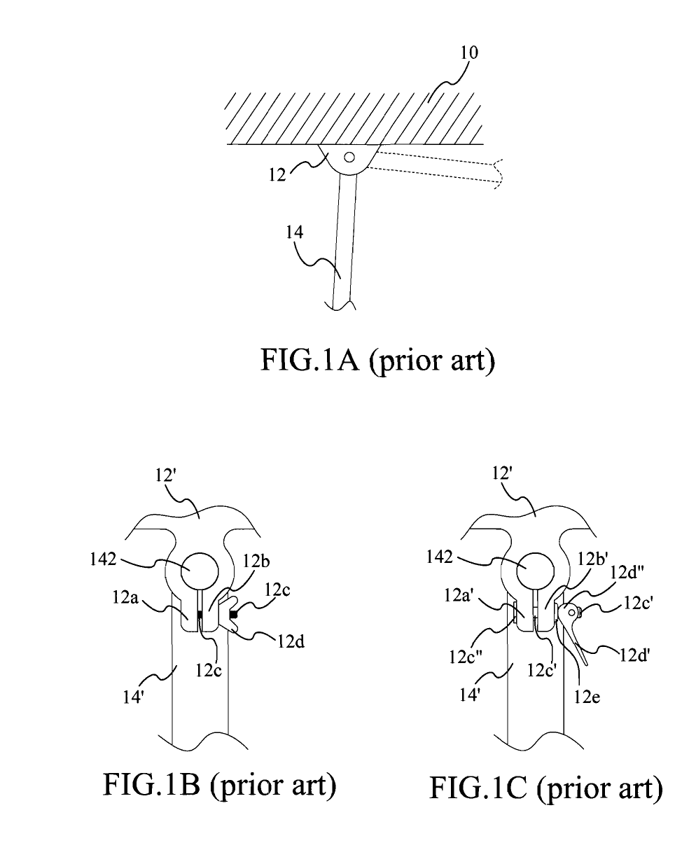

### DETAILED DESCRIPTION OF THE INVENTION

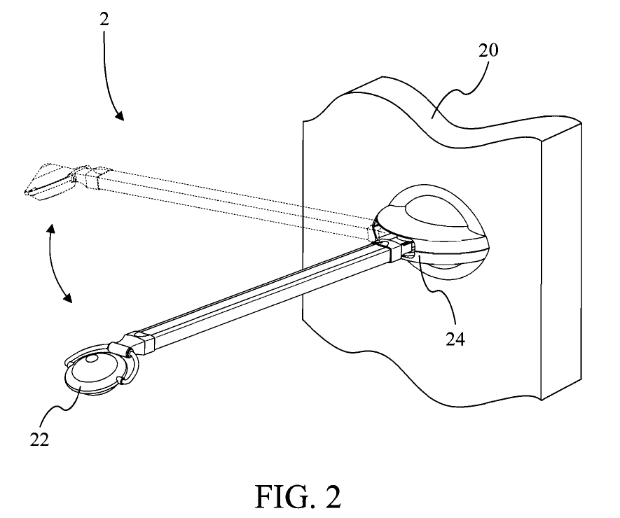

Please refer to FIG. 2. FIG. 2 is a schematic drawing of a camera apparatus 2 according to a preferred embodiment of the present invention. The camera apparatus 2 mainly contains a camera 22 as well as a support frame 24 used to support the camera 22. The support frame 24 is fixed in the wall surface 20. As shown in FIG. 2, by the locating design of the rotary joint device 242 of the present invention, the camera 22 has two localization positions related to the wall surface 20 (the dotted line is another localization position), which may serve as operation positions and restoration positions. Certainly, this invention is not limited by this embodiment and may be dependent upon the demand to provide more localization.

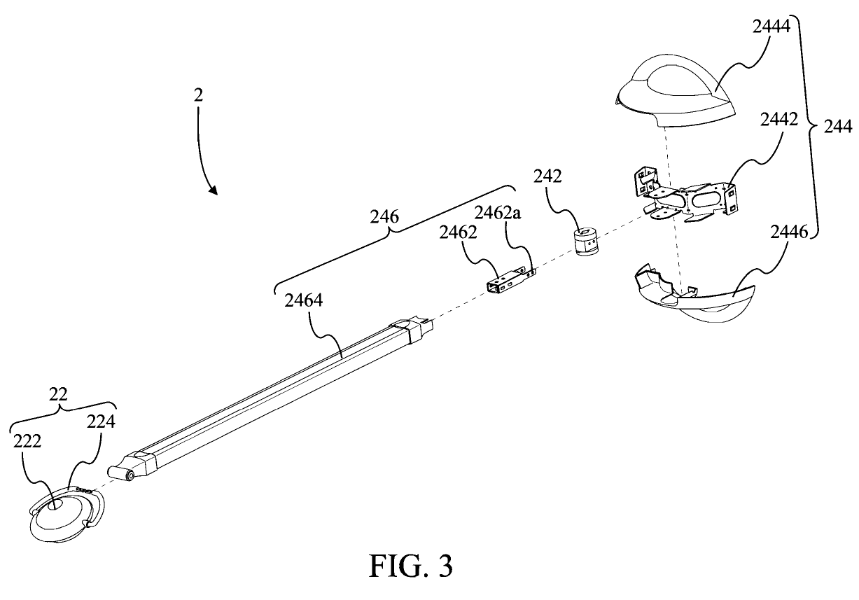

Please refer to FIG. 3. FIG. 3 is an exploded schematic drawing of the camera apparatus 2. The support frame 24 contains a first frame 244, a rotary joint device 242, and a second frame 246. The first frame 244 contains a bracket 2442 and a cover combined with an upper cover 2444 and a bottom cover 2446. The first frame 244 is connected with the rotary joint device 242 through the bracket 2442. The second frame 246 contains a fixed frame 2462 and an extended support frame 2464 which are combined with the fixed frame 2462. The second frame 246 is, by the fixed frame 2462, connected with the rotary joint device 242. The video camera 22 contains a camera lens 222 and a camera lens support frame 224. The camera lens support frame 224 is connected with the camera lens 222 and the extended support frame 2464 of the second frame 246. The camera lens 222 is connected to the camera lens support frame 224 pivotally, thus, the camera lens 222 can rotate relative to the camera lens support frame 224.

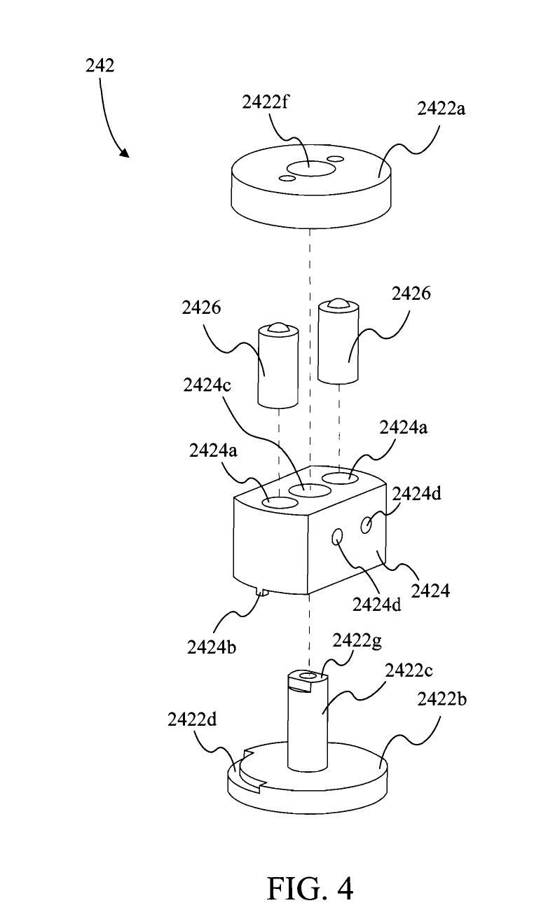

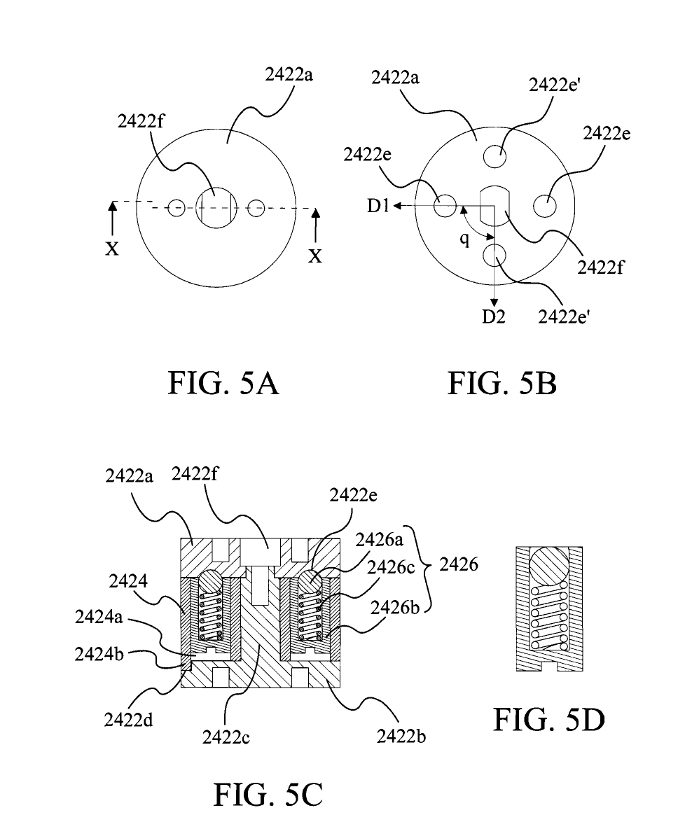

Please refer to FIG. 4. FIG. 4 is the exploded schematic drawing of the rotary joint device 242 shown in FIG. 3. The rotary joint device 242 contains a first rotary member composed of a first base 2422a, a second base 2422b, and a shaft 2422c, a second rotary member 2424 which is connected with the first rotary member pivotally, and two positioning devices 2426. The shaft 2422c is placed between the first base 2422a and the second base 2422b, and is fixed on the second base 2422b. One end part 2422g of the shaft 2422c is non-circular-shaped. The first base 2422a includes a positioning hole 2422f, and the non-circular-shaped end part 2422g is plugged in the positioning hole 2422f, so as to maintain the relative position of the first base 2422a and the second base 2422b. The way of engagement may refer to FIG. 5C. The second rotary member 2424 uses the shaft hole 2424c to connect the shaft 2422c pivotally, and it contains two holes 2424a to accommodate the positioning devices 2426. The positioning devices 2426 are connected with the second rotary member 2424 and urged against the first bass 2422a. Because of urge, the two positioning devices 2426 would be engaged into either the first positioning recess spaces 2422e or the second positioning recess spaces 2422e′ of the first base 2422a (Please refer to FIG. 5B and FIG. 5C), which achieves the localization function accordingly. In addition, the second rotary member 2424 includes a position-limited column 2424b; the second base 2422b includes a sliding groove 2422d, and the position-limited column 2424b is limited to slide in the sliding groove 2422d. By doing so, rotation range of the second rotary member 2424 is limited relative to the first rotary member.

It should be noted that, in this example of implementation, the fixed frame 2462 uses two arms 2462a to be connected with the second rotary member 2424. As shown in FIG. 4, the second rotary member 2424 has two spiral hole 2424d used to connect with the arms 2462a with external screws. Certainly, this invention is not limited to this implementation. For example, a hole (i.e. female thread) is provided on the second rotary member 2424 and the fixed frame 2462 contains a bolt (i.e. pin thread) correspondingly. Please refer to FIG. 5A to FIG. 5C. FIG. 5A is a top view of the rotary joint device 242. FIG. 5B is a bottom view of the first base 2422a. FIG. 5C shows the rotary joint device 242 in the sectional drawing of the line X-X of the FIG. 5A. As shown in FIG. 5C, the non-circular-shaped end part 2422g of the shaft 2422c gets inserted into only a part of the positioning hole 2422f of the first base 2422a, and the positioning hole 2422f is locked by screws (not shown in FIG. 5) into the spiral hole of the non-circular-shaped end part 2422g of the shaft 2422c, so as to connect the first base 2422a with the second base 2422a through the shaft 2422c. Certainly, a washer can be provided between the screw and the non-circular-shaped end part 2422g of the shaft 2422c. In addition, this invention can uses a set of corresponding hole and shaft to realize the connection between the first base 2422a and the second base 2422b, and the section of the positioning hole 2422f is not necessary to be identical with the shape of the end of the shaft 2422c (as long as the section of the positioning hole 2422f could accommodate the shape of the end of the shaft 2422c).

As shown in FIG. 5C, the positioning device 2426 includes a positioning part 2426a, a body 2426b, and a resilient 2426c. The positioning part 2426a may be a metal sphere, for example, a steel ball. The resilient 2426c may be a spring. The body 2426b includes an accommodating space to place the spring 2426c and part of the steel ball of 2426a within. The steel ball 2426a is fettered by the aperture of the accommodating space of the body 2426b to compress the spring 2426c. The engagement between the positioning device 2426 and the hole 2424a of the second rotary member 2424 may be tightly connected, for example, by using a set of pin and female threads provided on the hole 2424a of the second rotary member 2424 and the body 2426b of the positioning device 2426 respectively. Or, when the hole 2424a of the second rotary member 2424 is a blind hole or a structure which can wedge the body 2426b (e.g. a hole with the stepped inside diameter), the body 2426b of the positioning device 2426 may be simply placed in this hole 2424a, which will achieve the goal of connection.

Please refer to FIG. 5B. The steel ball 2426a is urged against the first positioning recess space 2422e of the first base 2422a. When the second rotary member 2424 rotates relative to the first rotary member (because the body 2426b of positioning device 2426 will not move relatively to the second rotary member 2424 in the vertical direction), the steel ball 2426a will be pushed downward and compress the spring 2426c, as shown in FIG. 5D. And, when the second rotary member 2424 rotate 90 degrees, the steel ball 2426a would be pushed into the second positioning recess space 2422e′ by the elastic force of the compressed spring 2426c so as to achieve the localization function. In addition, when the positioning device 2426 and the hole 2424a of the second rotary member 2424 are engaged by thread structure, the base 2426b of the body 2426b of the positioning device 2426 may form in-line or cruciform groove, for a user to adjust the relative distance of the positioning device 2426 with the first base 2422a (i.e. adjusting the strength of engagement between the steel ball 2426a and the first base 2422a). For example, if the positioning device 2426 shown in FIG. 5C is lowered, the strength given to the first base 2422a will be decreased. However, it should be noted that the shapes of the positioning recess space 2422e and 2422e′ are unnecessary to be identical with that of the steel ball 2426a; as long as the shapes of the positioning recess space 2422e and 2422e′ could accommodate the shape of the steel ball 2426a. In other words, the positioning recess space 2422e and 2422e′ may also be a blind hole or a through hole, and so on.

Please refer to FIG. 5B, which demonstrates that the rotary joint device 242 has two localization positions in 90 degree relation. Please refer to the schematic drawing of the FIG. 2. In FIG. 2, the steel ball 2426a of the positioning device 2426 of the camera apparatus 2 is located at the first positioning recess space 2422e, i.e. the second frame 246 was in a operation position along the first direction D1, while the restoration position is located along the second direction D2, wherein the included angle θ of these two directions D1 and D2 is 90 degrees. However, it is not limited to 90 degrees; it may be other angles, such as 30 degrees, 45 degrees, or 60 degrees, and so on. Besides, the number of the included angle θ for localization is not limited to one; it is allowed to have various localization angles, depending on the product design or demands. Also, the number of the positioning recess space for one localization position is not limited to two (in the embodiment, each localization position uses two positioning recess spaces (two first positioning recess space 2422e and two second recess spaces 2422e′)). It depends on strength for localization or stabilization for the structure.

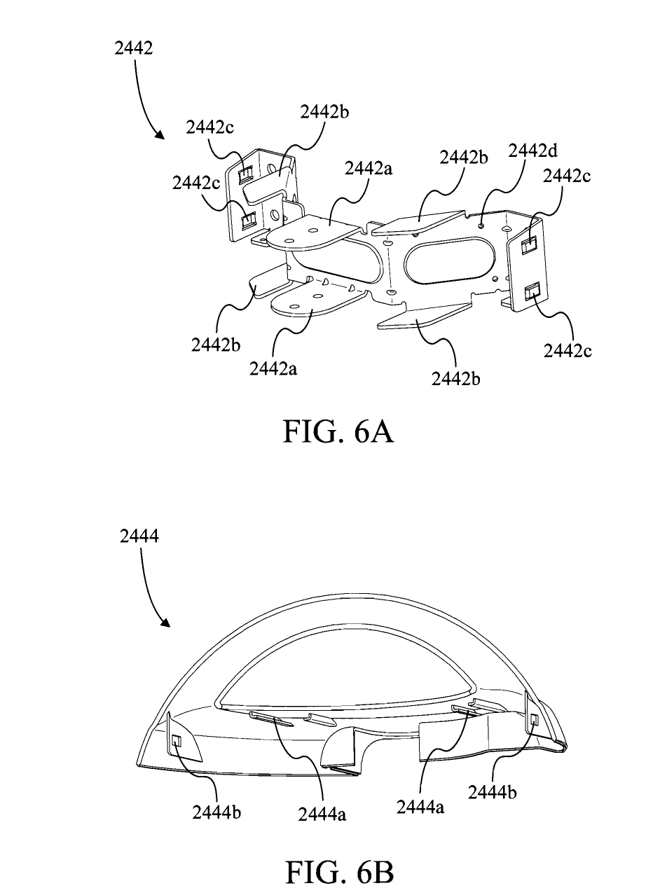

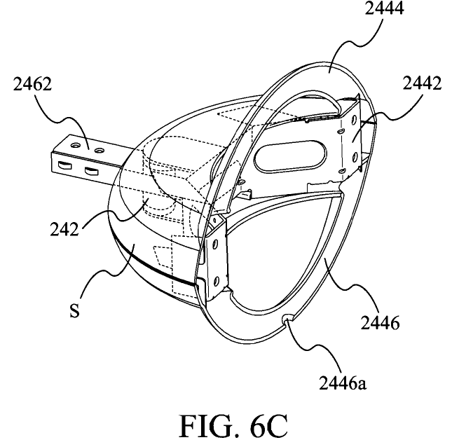

Please refers to FIG. 6A, which is a schematic drawing of the bracket 2442 of the first frame 244 showed in FIG. 3. The bracket 2442 contains a fixing plate 2442a to firmly connect with the first base 2422a and the second base 2422b of the rotary joint device 242. Please refer to FIG. 6B, which is the schematic drawing of the upper cover 2444 of the first frame 244 shown in FIG. 3. The bracket 2442 contains four guiding plates 2442b and the upper cover 2444 contains two sliding grooves 2444a (the bottom cover 2446 also contains two sliding grooves). When the guiding plate 2442b slides into the sliding grooves 2444a, it causes the upper cover 2444 to be connected to the bracket 2442 appropriately. Moreover, the bracket 2442 contains four protrusions 2442c; the upper cover 2444 contains two apertures 2444b (or recess); and the protrusions 2442c is fitted into the aperture 2444b to assist the upper cover 2444 to be fixed onto the bracket 2442.

It should be noted that, in this preferred embodiment, the fixing plate 2442a uses two screws (not shown in the figure) to firmly connect with the first base 2422a and the second base 2422b of the rotary joint device 242. However, there has other way to make connection. For example, directly adhere or weld the fixing plate 2442a to the first base 2422a and the second base 2422b; produce the first base 2422a and the second base 2422b together with the fixing plate 2442a into a single piece. Namely, the fixing plate 2442a serves as a part of the first base 2422a and the second base 2422b.

Please refers to FIG. 6C, which is the schematic drawing of the portion of the support frame 24 shown in FIG. 2. The viewing angle of FIG. 6C is different from that of FIG. 2, and the dotted line in the figure is used to express the positions of the related parts for the support frame 24. As FIG. 6C shows, a line placing space S is formed for placing the lines when the upper cover 2444 and the bottom cover 2446 are connected to the bracket 2442. The bottom cover 2446 also contains a hole 2446a for external line to pass through the line placing space S. Besides, a plurality of holes 2442d of the bracket 2442 are provide to serve as cord storage for the lines in the line placing space S to avoid entwining.

To sum up, this invention uses the positioning part to engage into the first positioning recess space or the second positioning recess space to achieve the localization function. Moreover, by means of combination of position and number of the positioning recess space, it is easy to achieve multi-positioning, simplified operation, and increase of structure reliability.

Although the present invention has been illustrated and described with reference to the preferred embodiment thereof, it should be understood that it is in no way limited to the details of such embodiment but is capable of numerous modifications within the scope of the appended claims.

What is claimed is:

1. A rotary joint device comprising:
a first rotary member comprising a first positioning recess space and a second positioning recess space;
a second rotary member pivotally engaged with the first rotary member and comprising a hole; and
a positioning device comprising a body, a resilient, and a positioning part, the body comprising an accommodating space, the resilient being accommodated in the accommodating space and connected to the body and the positioning part respectively, the body being disposed in the hole and is connected to the second rotary member, the positioning part being urged against the first rotary member and being accommodated in the first positioning recess space or the second positioning recess space.

2. The rotary joint device of claim 1, wherein the first rotary member comprises a first base, a second base and a shaft, the shaft is disposed between the first base and the second base and is fixed on the second base, and the second rotary member comprising a shaft hole, and the shaft passing through the shaft hole.

3. The rotary joint device of claim 2, wherein the shaft comprises an non-circular-shaped end part, the first base comprising a positioning hole, and the end part being plugged in the positioning hole.

4. The rotary joint device of claim 3, further comprising a screw, wherein the non-circular-shaped end part comprises a tapped hole, and the screw is locked in the spiral hole to against the first base.

5. The rotary joint device of claim 2, wherein a first direction is defined to pass through the shaft hole and the first positioning recess space, a second direction is defined to pass through the shaft hole and the second positioning recess space, wherein an included angle is provided between the first direction and the second direction.

6. The rotary joint device of claim 5, wherein the included angle is 30 degrees, 45 degrees, 60 degrees or 90 degrees.

7. The rotary joint device of claim 2, wherein the second rotary member comprises a position-limited column, the second base comprises a sliding groove, and the position-limited column limitedly sliding in the sliding groove.

8. The rotary joint device of claim 1, wherein the shaft hole includes a female thread, the body includes a corresponding female thread, which the body is adjustable linked with the shaft hole.

9. The rotary joint device of claim 1, wherein the positioning part is a metal sphere.

10. The rotary joint device of claim 1, wherein the resilient is a spring.

11. A support frame comprising:
a first rotary member comprising a first positioning recess space and a second positioning recess space;
a first frame connected with the first rotary member;
a second rotary member pivotally engaged with the first rotary member and comprising a hole;
a second frame connected with the second rotary member, and
a positioning device comprising a body, a resilient, and a positioning part, the body comprising an accommodating space, the resilient being accommodated in the accommodating space and is connected to the body and the positioning part respectively, the body being disposed in the hole and is connected to the second rotary member, the positioning part being urged against the first rotary member and being accommodated in the first positioning recess space or the second positioning recess space.

12. The support frame of claim 11, wherein the first rotary member comprising the first base, the second base, and the shaft, the first rotary member comprising a first base, a second base and a shaft, the shaft is placed between the first base and second base and is fixed on the second base, the second rotary member comprising a shaft hole, the shaft pass through the shaft hole.

13. The support frame of claim 12, wherein the second frame comprising a fixed frame and a extended support frame.

14. The support frame of claim 11, wherein the first frame comprises a bracket and a cover, the bracket comprises a guiding plate, and the cover comprises a sliding groove, and the guiding plate is set up in the sliding groove.

15. The support frame of claim 11, wherein the first frame contains a bracket and a cover, the bracket contains a protrusion, the cover contains an aperture, and the protrusion is fitted with the aperture.

16. The support frame of claim 11, wherein the first frame contains a bracket and a cover, and a line placing space is formed for placing the lines when the cover is connected to the bracket, and the cover contains a hole for a external line to pass through the line placing space.

17. The support frame of claim 16, wherein the accommodating space comprises a cord storage.

18. A camera apparatus comprising:
a first rotary member comprising a first positioning recess space and a second positioning recess space;
a first frame connected with the first rotary member;
a second rotary member pivotally engaged with the first rotary member and comprising a hole;
a second frame connected with the second rotary member;
a positioning device comprising a body, a resilient, and a positioning part, the body comprising an accommodating space, the resilient being accommodated in the accommodating space and connected to the body and the positioning part respectively, and the body being disposed in the hole and connected to the second rotary member, and the positioning part being urged against the first rotary member and accommodated in the first positioning recess space or the second positioning recess space, and
a video camera engaged with the second frame.

19. The video camera device of claim 18, wherein the video camera contains a camera lens support frame and a camera lens, and the camera lens support frame pivotally is engaged with the camera lens and the second frame.
